(19) United States
(12) Patent Application Publication
(10) Pub. No.: US 2015/0046161 A1
(43) Pub. Date: Feb. 12, 2015

(54) DEVICE IMPLEMENTED LEARNING VALIDATION

(71) Applicant: Lenovo (Singapore) Pte. Ltd., Singapore (SG)

(72) Inventors: Howard Locker, Cary, NC (US); Richard Wayne Cheston, Pittsboro, NC (US); Goran Hans Wibran, Cary, NC (US); John Weldon Nicholson, Cary, NC (US)

(73) Assignee: Lenovo (Singapore) Pte. Ltd., Singapore (SG)

(21) Appl. No.: 13/961,542

(22) Filed: Aug. 7, 2013

(51) Int. Cl. G10L 15/02

(52) U.S. Cl. CPC G10L 15/02
USPC 704/246

(57) ABSTRACT

An aspect provides a method, including: collecting, at one or more device sensors, one or more inputs selected from the group of inputs consisting of audio inputs from a learning environment and visual inputs from a learning environment; processing, using one or more processors, the one or more inputs to detect an unauthorized behavior pattern; mapping, using the one or more processors, the unauthorized behavior pattern to a predetermined action; and executing the predetermined action. Other aspects are described and claimed.

### BACKGROUND

In the context of learning environments, when testing (or like evaluations) is utilized it is desirable to implement measures to validate the results of such testing. For example, when giving students a test, it is common for a proctor to monitor the students in order to ensure that none of the students has gained an unfair advantage.

Modern learning environments are complex. For example, technology now exists to give device implemented tests (e.g., using computers) either to groups (e.g., a group of students in a traditional classroom using mobile computing devices, a group of students in a traditional classroom with dedicated workstations, a group of test takers at a testing center, etc.) or an individual taking a computer implemented test, e.g., as often occurs in distance learning environments.

In use cases such as distance learning, which are rapidly emerging and gaining in popularity, verification is also required and can be considerably more challenging when compared to a proctored exam. As an example, it must be verified that the person (source, student, test taker) inputting information remotely or responding to questions remotely is not only the actual test taker, but additionally that the test taker is not receiving extraneous coaching and/or input from another.

### BRIEF SUMMARY

In summary, one aspect provides a method, comprising: collecting, at one or more device sensors, one or more inputs selected from the group of inputs consisting of audio inputs from a learning environment and visual inputs from a learning environment; processing, using one or more processors, the one or more inputs to detect an unauthorized behavior pattern; mapping, using the one or more processors, the unauthorized behavior pattern to a predetermined action; and executing the predetermined action.

Another aspect provides an information handling device, comprising: one or more of an audio sensor and a visual sensor; one or more processors; and a memory accessible to the one or more processors storing instructions executable by the one or more processors to: collect, at one or more of the audio sensor and the visual sensor, one or more inputs selected from the group of inputs consisting of audio inputs from a learning environment and visual inputs from a learning environment; process the one or more inputs to detect an unauthorized behavior pattern; map the unauthorized behavior pattern to a predetermined action; and execute the predetermined action.

A further aspect provides a product, comprising: a computer readable storage medium storing instructions executable by one or more processors, the instructions comprising: computer readable program code configured to collect, at one or more device sensors, one or more inputs selected from the group of inputs consisting of audio inputs from a learning environment and visual inputs from a learning environment; computer readable program code configured to process the one or more inputs to detect an unauthorized behavior pattern; computer readable program code configured to map the unauthorized behavior pattern to a predetermined action; and computer readable program code configured to execute the predetermined action.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates an example method of detecting an unauthorized behavior pattern using audio information.

FIG. 3 illustrates an example method of detecting an unauthorized behavior pattern using visual information.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Existing solutions for device implemented learning validation may authenticate the person (student, test taker, source) at login time and/or even use various continuous authentication methods, but there currently is no way of knowing if the person has received external coaching and/or input, short of having a proctor in the same location. Thus, for distance learning, this is not practical. Moreover, even in learning environments where a proctor may be present, test takers may gain an advantage by looking to others for information or otherwise accessing unauthorized help.

Accordingly, embodiments provide device implemented learning validation wherein device inputs, e.g., audio and/or visual inputs, may be used, either alone or in combination with one another and/or other inputs, e.g., answers to test questions, seating charts, timing information, biometric information, and the like, are utilized to assist in the learning validation process. Embodiments may employ pattern recognition techniques, e.g., as applied to the various inputs available (e.g., audio and/or visual device inputs, etc.) in order to detect a pattern indicative of unauthorized behavior. If such a pattern or patterns is/are detected, an embodiment may provide an indication, e.g., a warning or message to a system-level user, that such an unauthorized behavior pattern has been detected. This may lead to further investigation or validation steps or actions, either in real time (e.g., via a proctor making a check (in room or via video, etc.)) or as a post-processing step (e.g., after test or activity completion).

The illustrated example embodiments will be best understood by reference to the figures. The following description is intended only by way of example, and simply illustrates certain example embodiments.

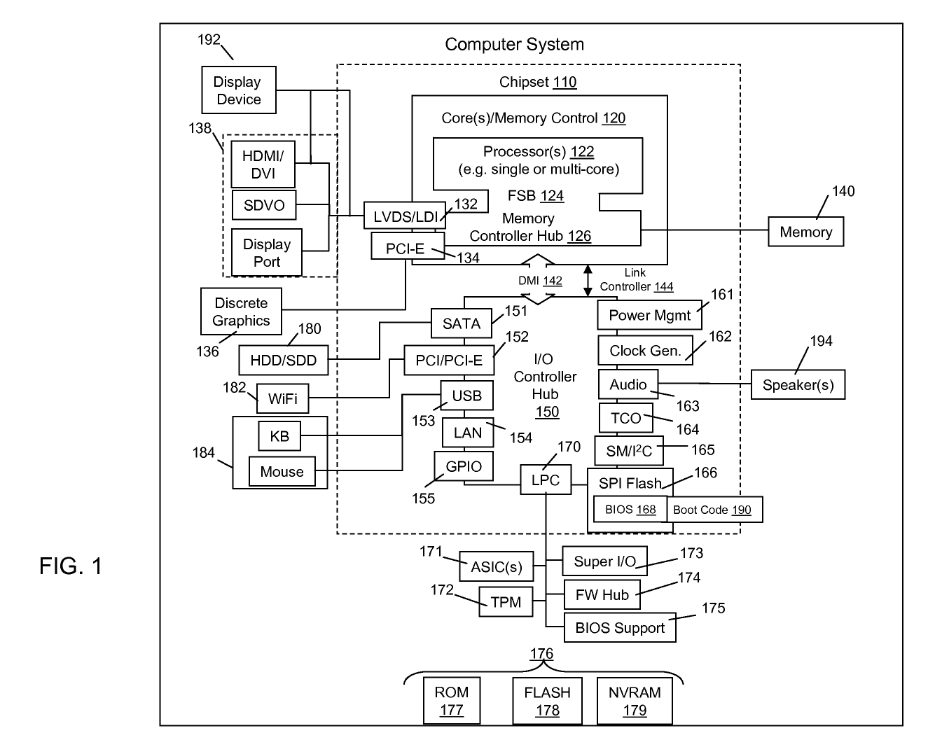

While various other circuits, circuitry or components may be utilized in information handling devices, FIG. 1 depicts a block diagram of an example of information handling device circuits, circuitry or components. The example depicted in FIG. 1 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 1.

The example of FIG. 1 includes a so-called chipset 110 (a group of integrated circuits, or chips, that work together, chipsets) with an architecture that may vary depending on manufacturer (for example, INTEL, AMD, ARM, etc.). The architecture of the chipset 110 includes a core and memory control group 120 and an I/O controller hub 150 that exchanges information (for example, data, signals, commands, et cetera) via a direct management interface (DMI) 142 or a link controller 144. In FIG. 1, the DMI 142 is a chip-to-chip interface (sometimes referred to as being a link between a “northbridge” and a “southbridge”). The core and memory control group 120 include one or more processors 122 (for example, single or multi-core) and a memory controller hub 126 that exchange information via a front side bus (FSB) 124; noting that components of the group 120 may be integrated in a chip that supplants the conventional “northbridge” style architecture.

In FIG. 1, the memory controller hub 126 interfaces with memory 140 (for example, to provide support for a type of RAM that may be referred to as “system memory” or “memory”). The memory controller hub 126 further includes a LVDS interface 132 for a display device 192 (for example, a CRT, a flat panel, touch screen, et cetera). A block 138 includes some technologies that may be supported via the LVDS interface 132 (for example, serial digital video, HDMI/DVI, display port). The memory controller hub 126 also includes a PCI-express interface (PCI-E) 134 that may support discrete graphics 136.

In FIG. 1, the I/O hub controller 150 includes a SATA interface 151 (for example, for HDDs, SDDs, 180 et cetera), a PCI-E interface 152 (for example, for wireless connections 182), a USB interface 153 (for example, for devices 184 such as a digitizer, keyboard, mice, cameras, phones, microphones, storage, other connected devices, et cetera), a network interface 154 (for example, LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, a clock generator interface 162, an audio interface 163 (for example, for speakers 194), a TCO interface 164, a system management bus interface 165, and SPI Flash 166, which can include BIOS 168 and boot code 190. The I/O hub controller 150 may include gigabit Ethernet support.

The system, upon power on, may be configured to execute boot code 190 for the BIOS 168, as stored within the SPI Flash 166, and thereafter processes data under the control of one or more operating systems and application software (for example, stored in system memory 140). An operating system may be stored in any of a variety of locations and accessed, for example, according to instructions of the BIOS 168. As described herein, a device may include fewer or more features than shown in the system of FIG. 1.

Information handling devices, as for example outlined in FIG. 1, may provide a workstation or device on which a test taker may engage in learning activities, e.g., take an examination. For example, such a device may be utilized by students in a classroom, by test takers at a dedicated testing center, or even by distance learning students (e.g., individuals remotely taking tests or completing activities requiring input of some kind) In this regard, while “students” and “test” or “exam” are used as examples herein, the various embodiments are not limited to these specific examples. Moreover, other devices than the device outlined in FIG. 1 may be utilized, or combinations of devices may be utilized.

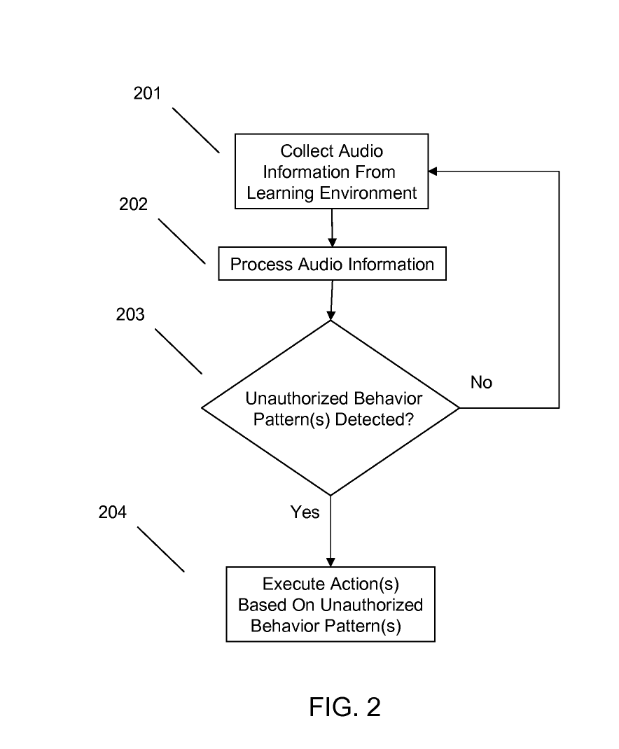

In one embodiment, illustrated in FIG. 2, a stereo microphone or array microphones of a device on which the user is inputting his or her responses is/are employed in order to collect audio inputs from the learning environment at 201. The audio information collected may be processed after collection at 202. For example, using such an audio system, the direction of arrival of sound information can be determined at 201. This may facilitate determination that audio is received from different physical locations within the learning environment, e.g., from a person speaking from different locations, from more than one person in the location, etc. As another example, an embodiment may process the audio information at 201 to perform speaker detection and/or recognition. This may facilitate determinations regarding how many speakers are detectable in the audio information, the identity of one or more speakers in the collected audio information, etc. For example, an embodiment may detect (e.g., with some probability) the number of people that are talking based upon features of the voice data itself, such as the “fundamental frequency”. A variety of speaker recognition techniques may also be employed, e.g., based on audio samples of various predetermined speaker(s) (e.g., the test taker, other students, etc.).

Based on the processing of the audio information at 202, an embodiment utilizes a classification scheme to make a determination of whether an unauthorized behavior pattern or patterns are detected at 203. If an unauthorized behavior pattern is detected at 203, an embodiment may execute an action responsive thereto at 204.

For example, an embodiment may analyze the audio information collected at 201 to determine at 203 if a test taker should be flagged as suspicious at 204. More than one action may be taken at 204. For example, in addition to flagging the student as suspicious at 204, an embodiment may suggest that the student be reviewed (e.g., by implementing a video feed if a proctor is available to visually view the student or a review of the student's test after test completion, e.g., in a distance learning context where no proctor is able to view the student in real time). A challenge solved by an embodiment is providing the ability to determine, using device inputs such as audio information collected via a microphone array, if the user is being coached by somebody else (which should be flagged), or whether a student is simply talking to themselves, listening to music, listening to talk radio, etc.

In terms of classification, an embodiment employs an intelligent classification scheme to sort out or parse standard audio information (e.g., little or no speaking), anomalous yet harmless/authorized audio information (e.g., listening to music or a radio talk show, student talking to himself/herself, etc.) and actual unauthorized behavior (e.g., another speaker providing answers or suggestions). An example of such classification involves the following.

At 203, an embodiment may determine if unauthorized behavior is detectable in the audio information. This may include determining if more than one speaker is detectable in the audio information collected at 201. Determining if more than one speaker is present in the audio information may be implemented in a variety of ways. For example, an analysis of audio collected via a microphone array may indicate that sources of audio are located at different physical locations within the learning environment. This is possible due to the physical spacing between the microphones of the array and timing information of the audio signals received, e.g., close in time. Thus, each microphone in the array will detect speakers in different locations at slightly different times, which may in turn be used to infer the presence of more than one speaker. Additionally or alternatively, more complex speaker detection and/or speaker recognition mechanisms may be employed, e.g., analysis of the speech characteristics captured in the wave forms of the audio information. Thus, an embodiment may distinguish between a speaker at one end of a room and a speaker located more centrally (e.g., directly in front of the device used to input test answers).

Other approaches to detecting more than one speaker are possible. For example, an embodiment may utilize amplitude information to determine an approximate distance between the speaker in question and a microphone of the microphone array. Thus, speakers located in different physical locations will be distinguishable. Additional or different analyses may be performed as well. For example, if two or more speakers are identified in the audio information, an analysis of the audio information may be conducted to differentiate between background noise, e.g., as produced by a radio program, and a human speaker in the room. This may include characterizing the audio signals to detect consistent patterns, e.g., a radio program would produce a relatively consistent stream of audio data, to detect certain speakers (e.g., speaker recognition) or the like. These various methods of determining if more than one speaker is detectable in the audio information (used either alone or in some suitable combination) may be used to determine at 203 that an unauthorized behavior pattern is detected, e.g., more than one speaker present during an online exam.

Various thresholds may be implemented, e.g., with respect to probability or confidence in the determination that unauthorized behavior pattern(s) are detected, e.g., more than one speaker is detected and/or duration of the anomalous detection. These thresholds moreover may be mapped to various actions, e.g., depending on the probability or confidence of the determination. An embodiment may also listen for key words, e.g., key words related to the questions on a test. Thus, in the case where a second person is detected in the audio repeating key words or phrases from a question, an embodiment may detect an unauthorized behavior pattern. A flag indicating a possible unauthorized behavior pattern has been detected may be set in response to a low-confidence determination that more than one speaker has been detected. This may be coupled with a link to an audio file of the audio information used to make the low-confidence determination, e.g., for a human review of the audio information to determine if indeed more than one speaker is present. In contrast, a high-confidence determination that more than one speaker has been detected may trigger a flag being set and an identification of the speaker(s) recognized in the audio information (in a case where speaker recognition is employed).

As part of the threshold(s) or classifications, an embodiment may employ more detailed pattern recognition techniques depending on what information is available regarding the learning environment in question. For example, an embodiment may leverage stored information regarding a particular user (e.g., test taker), a particular test characteristic (e.g., a particular question), a particular testing environment, etc., in order to refine the analysis of the audio inputs.

For example, an embodiment may make an initial determination that a speaker is detected in the audio information. An embodiment may thereafter, as part of detecting an unauthorized behavior pattern at 203, determine if this is characteristic or uncharacteristic for this particular user, for this particular question, for this particular group of users, for this particular testing environment, or characteristic for a particular relevant comparison data set (e.g., a similar test taker, a similar group, etc. Thus, if it is known to an embodiment (e.g., based on accessing a data base for example storing a user history) that a particular user has a habit of reading word problems out loud, the detection of a speaker in the audio information may not warrant setting a flag, or may warrant setting a flag and indicate that further analysis (e.g., manual analysis) is warranted. Similarly, if a particular question elicits verbal responses from users, e.g., based on information derived from a group of users, it is known that a particular question or part thereof is read out loud by a plurality of users and thus is considered normal, a similar analysis and flagging scenario may be employed. In contrast, if it is known that a particular user never verbalizes questions or parts thereof, detection of audio may be a stronger indication of an unauthorized behavior pattern.

Thus, given access to one or more data bases storing contextual information (e.g., about a user, about a question, about a testing environment, etc.), an embodiment may refine the determination of unauthorized behavior pattern detection at 203 such that an appropriately tailored flag (or lack thereof) is implemented.

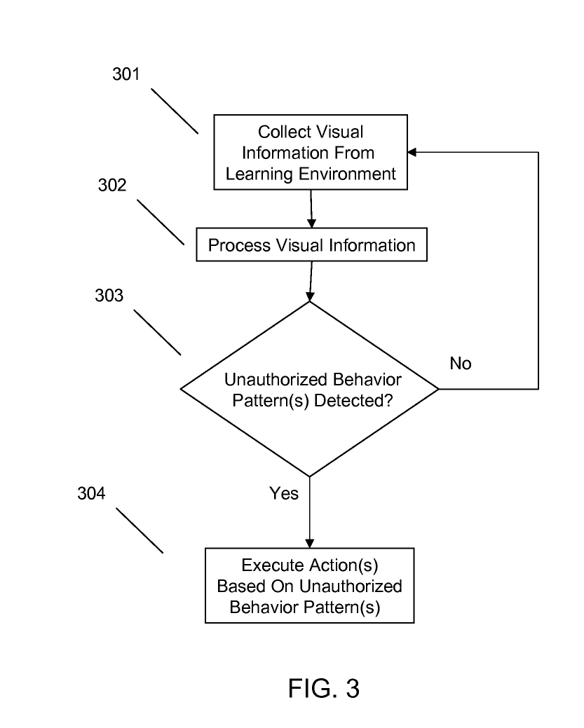

As illustrated in FIG. 3, an embodiment may collect visual information at 301 (e.g., as for example captured by a camera or motion detection system) and process the visual information at 302 to detect an unauthorized behavior pattern 303. For example, an embodiment may use a camera embedded in the device to implement gaze tracking of the person inputting the information at the device. The visual information available is refined to the point that an embodiment may determine small movements, e.g., of the eyes. For example, utilizing gaze tracking, an embodiment may distinguish between a user looking forward at a display screen and a user looking just above the display screen or next to the display screen, etc. Thus, an embodiment may track the direction of the person's eyes (gaze) and time stamp this information for synchronization of it to test inputs.

An embodiment may process the visual information at 302 in order to establish or infer a relationship between the user's gaze and other inputs, e.g., the test inputs (e.g., keyboard and/or mouse inputs) in order to detect an unauthorized behavior patter 303. Using this relationship data an embodiment may determine (again, with varying degrees of probability or confidence) that an unauthorized behavior pattern has taken place, e.g., the user is receiving external coaching and/or input, the user is looking to another user's answers, etc.

For example, if a user were copying from another source, e.g., a student located to the right of the user, the person's gaze would look away from the screen to the other source before answering each question or a series of questions. As with the techniques described in connection with the processing of audio information and analysis thereof, an embodiment may also compare the user's visual information, e.g., gazing distribution, to the others taking the same test or historical information (e.g., others taking the test in the past, others taking a test in the same learning environment, or the like). For example, an embodiment may compare a user's gazing distribution to previous tests that the particular user has taken. Significant outliners (e.g., two or more standard deviations) may be flagged as indicative or an unauthorized behavior and serve as the basis for performing one or more actions at 304, e.g., triggering a flag to be set for this particular user, etc.

In the context of a group of users, e.g., a group of test takers in a classroom, an embodiment may check each user in the group for a percentage of time spent looking away from the screen (e.g., from his or her workstation to another location). If a particular user has a significantly higher percentage than a threshold, e.g., as previously determined or as determined dynamically based on the other users (as in this example), a flag may be set flag. Moreover, given the directionality information, i.e., in which direction is the user looking, action(s) based on the direction in which the user is looking may be made. For example, an action may include incorporating additional data into the unauthorized behavior pattern analysis of 303. Thus, if a user is detected as gazing to the right at a certain frequency and/or duration, information regarding the user to the right may be utilized, e.g., to compare answers input by the two students, the timing thereof, etc. Thus, the pattern detection or analysis may include using both inputs from a particular user's device and other inputs, e.g., the answers of a student located in the direction of the user's view, to see if that information is further indicative of an unauthorized behavior patter. For example, if the user is detected as looking to the right a student's answers located to the right are similar (again, utilizing a threshold analysis), an embodiment may flag the user or the user's test for further scrutiny, issue a warning to the user, or the like.

An embodiment may include one or more mechanisms, e.g., a biometric logon, to ensure the appropriate user is taking the test. Attendance at the device, e.g., utilizing a biometric mechanism, may be used to perform such user authentication or verification periodically in order to make sure the student has not switched out with another person. Moreover, the testing application may preclude utilization of other device applications or components, e.g., via locking a test in a full screen mode, locking out browsers, etc., such that the test application is only application allowed to operate or be displayed on screen during the testing period. As another example, device hardware may be modified or monitored during the testing period, e.g., a microphone and/or speakers may be muted, in order to ensure that the user is not getting unauthorized assistance, e.g., audio clues. Additionally, inputs may be detected indicating an unauthorized behavior pattern. For example, a microphone mute action by a user may be indicative of an unauthorized behavior pattern, e.g., that a user is attempting to interfere with audio input into the system in order to get audio clues from another. Additionally, an embodiment may utilize patterns of input, e.g., unusual scrolling of screen contents or unusual input patterns (e.g., no input from a particular portion of a screen), as indicative of an unauthorized behavior pattern. For example, a user placing a handwritten note on a portion of the screen may lead to unusual scrolling or a lack of input (e.g., answer input) in that area of the display.

As with the use of audio information, an embodiment may include as part of the threshold(s) or classifications utilized with respect to the visual information (e.g., gaze tracking), more detailed pattern recognition techniques depending on what information is available regarding the learning environment in question. For example, an embodiment may leverage stored information regarding a particular user (e.g., test taker), a particular testing question (e.g., a particular question), etc., in order to refine the analysis of the visual inputs.

For example, an embodiment may make an initial determination that a user is detected looking away from the screen in a particular way, e.g., with a timing and/or direction that is indicative of an unauthorized behavior pattern. An embodiment may thereafter, as part of detecting an unauthorized behavior pattern at 303, determine if this is characteristic or uncharacteristic for this particular user, for this particular question, etc. Thus, if it is known to an embodiment (e.g., based on accessing user history stored in a data base) that a particular user has a habit of looking in a particular direction, e.g., downward, the detection of a downward gaze pattern in the visual information may not warrant setting a flag, or may warrant setting a flag and indicate that further analysis (e.g., manual analysis or checking) is warranted. Similarly, if a particular group of users are providing similar gaze tracking information (e.g., users seated along a window periodically gaze out the window), a similar analysis and flagging scenario may be employed. In contrast, if it is known that a particular user never or rarely gazes in directions other at the display screen, detection of a user gazing in different directions may be a stronger indication of an unauthorized behavior pattern.

Thus, given access to one or more data bases storing contextual information (e.g., about a user, about a question, about a testing environment, etc.), an embodiment may refine the determination of unauthorized behavior pattern detection at 303 such that an appropriately tailored flag (or lack thereof) is implemented.

An embodiment may employ one or more of the device inputs (e.g., derived from audio information and/or visual information) to detect unauthorized behavior patterns. Thus, a combination of audio information and visual information may be utilized in a classification of the behavior and/or in a comparison to one or more thresholds, calculations of confidence, etc. Therefore, utilizing embodiments, complex combinations of inputs may be utilized to determine if a user (or users) is/are exhibiting behavior (as detected using one or more device sensors) that is indicative of an unauthorized behavior pattern. This in turn may be utilized by an embodiment to appropriately tailor a notification and or review process.

The notification may be made in a variety of forms and the review process may include manual intervention, e.g., via a proctor, manual review of a test after it has been completed, review of underlying data utilized to make determine the unauthorized behavior pattern (e.g., review of audio and/or visual behavior), or even triggering of further automated review. For example, an embodiment may utilize a first detection of unauthorized behavior pattern(s) to initiate further analysis of the data that caused the detection (e.g., by comparing that data to other data sets for confirmation) and/or initiate further data collection (e.g., by turning on an additional device sensor to gain more data for use in further analysis, accessing inputs (e.g., answers) of other users and the like). Thus, many combinations of the above approaches may be utilized in order to initially detect unauthorized behavior, collect additional data, confirm an unauthorized behavior pattern, and/or take appropriate remedial action(s).

Accordingly, the various embodiments provide methods for detecting unauthorized behavior patterns in the context of a learning environment. Detection of such patterns may be utilized to validate the learning process, e.g., to flag certain test takers or tests as warranting further review. By implementing such methods, embodiments permit a higher degree of confidence that the learning process is valid and that users have not gained unfair advantages, e.g., such as coaching or input by someone else located in the testing environment, even in distance learning scenarios.

It will be readily understood by those having ordinary skill in the art that the various embodiments or certain features of the various embodiments may be implemented as computer program products in which instructions that are executable by a processor are stored on a computer readable or device medium. Any combination of one or more non-signal device readable medium(s) may be utilized. The non-signal medium may be a storage medium. A storage medium may be any non-signal medium, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), a personal area network (PAN), or the connection may be made through other devices (for example, through the Internet using an Internet Service Provider) or through a hard wire connection, such as over a USB connection.

Aspects are described herein with reference to the figures, which illustrate examples of inputs, methods, devices and program products according to various example embodiments. It will be understood that the actions and functionality illustrated may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified.

The program instructions may also be loaded onto a device to cause a series of operational steps to be performed on the device to produce a device implemented process such that the instructions which execute on the device provide processes for implementing the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
collecting, at one or more device sensors, one or more inputs selected from the group of inputs consisting of audio inputs from a learning environment and visual inputs from a learning environment;
processing, using one or more processors, the one or more inputs to detect an unauthorized behavior pattern;
mapping, using the one or more processors, the unauthorized behavior pattern to a predetermined action; and
executing the predetermined action.

2. The method of claim 1, wherein the processing comprises analyzing the audio inputs to detect more than one speaker;
the analyzing the audio inputs to detect more than one speaker comprising detecting, using data derived from a microphone array, distinguishable speech data signals within the audio inputs collected.

3. The method of claim 2, wherein the analyzing the audio inputs to detect more than one speaker comprises performing speaker recognition analysis to recognize at least one of two or more speakers detectable in the audio inputs collected.

4. The method of claim 2, wherein the analyzing the audio inputs to detect more than one speaker comprises performing speaker detection analysis to distinguish two or more speakers in the audio inputs collected.

5. The method of claim 1, wherein the detecting an unauthorized behavior pattern comprises accessing a data store of audio analysis information and comparing processed audio inputs collected from the learning environment to the audio analysis information.

6. The method of claim 5, wherein the data store of audio analysis information comprises audio analysis information selected from the group of audio analysis information consisting of: audio analysis information derived from a group of users; and audio analysis information derived from a single user.

7. The method of claim 1, wherein the detecting an unauthorized behavior pattern comprises accessing a data store of visual analysis information and comparing processed visual inputs collected from the learning environment to the visual analysis information.

8. The method of claim 1, wherein the processing comprises analyzing the visual inputs to detect a gaze pattern of a user; and
wherein the detecting an unauthorized behavior pattern comprises accessing a data store of visual analysis information and comparing the gaze pattern of the user to stored visual analysis information.

9. The method of claim 1, wherein the detecting an unauthorized behavior pattern comprises accessing additional data responsive to an initial detection of an unauthorized behavior pattern.

10. The method of claim 9, wherein the additional data comprises data derived from one or more test inputs provided by a user selected from the group of users consisting of: a user providing the visual information collected and another user located in the same learning environment.

11. An information handling device, comprising:
one or more of an audio sensor and a visual sensor;
one or more processors; and
a memory accessible to the one or more processors storing instructions executable by the one or more processors to:
collect, at one or more of the audio sensor and the visual sensor, one or more inputs selected from the group of inputs consisting of audio inputs from a learning environment and visual inputs from a learning environment;
process the one or more inputs to detect an unauthorized behavior pattern;
map the unauthorized behavior pattern to a predetermined action; and
execute the predetermined action.

12. The apparatus of claim 1, wherein to process comprises analyzing the audio inputs to detect more than one speaker;
the analyzing the audio inputs to detect more than one speaker comprising detecting, using data derived from a microphone array, distinguishable speech data signals within the audio inputs collected.

13. The apparatus of claim 12, wherein the analyzing the audio inputs to detect more than one speaker comprises performing speaker recognition analysis to recognize at least one of two or more speakers detectable in the audio inputs collected.

14. The apparatus of claim 12, wherein the analyzing the audio inputs to detect more than one speaker comprises performing speaker detection analysis to distinguish two or more speakers in the audio inputs collected.

15. The apparatus of claim 11, wherein to detect an unauthorized behavior pattern comprises accessing a data store of audio analysis information and comparing processed audio inputs collected from the learning environment to the audio analysis information.

16. The apparatus of claim 15, wherein the data store of audio analysis information comprises audio analysis information selected from the group of audio analysis information consisting of: audio analysis information derived from a group of users; and audio analysis information derived from a single user.

17. The apparatus of claim 11, wherein to detect an unauthorized behavior pattern comprises accessing a data store of visual analysis information and comparing processed visual inputs collected from the learning environment to the visual analysis information.

18. The apparatus of claim 11, wherein to process comprises analyzing the visual inputs to detect a gaze pattern of a user; and
wherein to detect an unauthorized behavior pattern comprises accessing a data store of visual analysis information and comparing the gaze pattern of the user to stored visual analysis information.

19. The apparatus of claim 11, wherein to detect an unauthorized behavior pattern comprises accessing additional data responsive to an initial detection of an unauthorized behavior pattern;
wherein the additional data comprises data derived from one or more test inputs provided by a user selected from the group of users consisting of: a user providing the visual information collected and another user located in the same learning environment.

20. A product, comprising:
a computer readable storage medium storing instructions executable by one or more processors, the instructions comprising:
computer readable program code configured to collect, at one or more device sensors, one or more inputs selected from the group of inputs consisting of audio inputs from a learning environment and visual inputs from a learning environment;
computer readable program code configured to process the one or more inputs to detect an unauthorized behavior pattern;
computer readable program code configured to map the unauthorized behavior pattern to a predetermined action; and
computer readable program code configured to execute the predetermined action.
